(19) United States
(12) Patent Application Publication
(10) Pub. No.: US 2015/0321845 A1
(43) Pub. Date: Nov. 12, 2015

(54) TRANSFER DEVICE

(71) Applicant: MURATA MACHINERY, LTD., Kyoto-shi, Kyoto (JP)

(72) Inventor: Akitoshi NAKAMURA, Inuyama-shi (JP)

(21) Appl. No.: 14/423,773

(22) PCT Filed: Jul. 29, 2013
(86) PCT No.: PCT/JP2013/070482

§ 371 Date: Feb. 25, 2015

(30) Foreign Application Priority Data
Sep. 5, 2012 (JP) 2012-195169

(51) Int. Cl. B65G 1/04

(52) U.S. Cl. CPC B65G 1/0435; B65G 1/0421

(57) ABSTRACT

A transfer device includes an arm, a conveyor, and a controller. The arm includes a first hook capable of entering and exiting a first abutment position that allows the first hook to abut the article, and a second hook being capable of entering and exiting a second abutment position that allows the second hook to abut the article. The controller moves the conveyor forward at a speed lower than a stretching speed of the arm when the article placed on the placement area is unloaded onto the shelf, and moves the conveyor rearward at a speed lower than a retracting speed of the arm when the article placed on the shelf is loaded onto the placement area.

### BACKGROUND OF THE INVENTION

1. Field of the Invention

The present invention relates to a transfer device configured to transfer an article to and from a shelf.

2. Description of the Related Art

As a transfer device for transferring an article to and from a shelf, for example, a transfer device that moves on rails extending along a plurality of shelves and transfers the article to and from the shelves is known (see PCT Publication No. WO2011/158422, for example). Such a transfer device is provided with, for example, an arm that can stretch and retract in a front-and-rear direction and a pair of hooks that are spaced apart from each other in the front-and-rear direction. In this transfer device, the hooks can to push and transfer the article by stretching forward or retracting rearward the arm with the hooks abutting the article.

As such a transfer device, a transfer device that includes, in addition to the arm, a conveyor provided below the arm is known (see Japanese Patent Application Laid-Open Publication No. 2012-71931 and Japanese Patent Application Laid-Open Publication No. 2012-71932, for example). In the transfer device having such an arm and a conveyor, articles can be moved by the arm and also by the conveyor.

In the transfer device as described above, it is desired to transfer the articles as stably as possible, by preventing occurrence of, for example, breakage and positional deviation of the articles.

### SUMMARY OF THE INVENTION

In view of this, preferred embodiments of the present invention provide a transfer device that stably transfers articles.

A transfer device according to a preferred embodiment of the present invention includes an arm configured to stretch forward along a front-and-rear direction to unload an article placed on a placement area onto a shelf, and retract rearward along the front-and-rear direction to load the article placed on the shelf onto the placement area; a conveyor provided at the placement area and configured to move the article along the front-and-rear direction; and a controller configured or programmed to control movement of the arm and the conveyor. The arm includes a first hook configured to enter and exit a first abutment position that allows the first hook to abut the article, the first hook being configured to enter the first abutment position to abut a rear end of the article placed on the placement area when unloading the article placed on the placement area onto the shelf; and a second hook configured to enter and exit a second abutment position that allows the second hook to abut the article, the second hook being configured to enter the second abutment position to abut a front end of the article placed on the shelf when loading the article placed on the shelf onto the placement area. The controller is configured or programmed to move the conveyor forward at a speed lower than a stretching speed of the arm when the article placed on the placement area is unloaded onto the shelf, and move the conveyor rearward at a speed lower than a retracting speed of the arm when the article placed on the shelf is loaded onto the placement area.

In this transfer device, the article is capable of being moved by the arm and the conveyor. When unloading the article placed on the placement area onto the shelf, the conveyor is moved forward at the speed lower than the stretching speed of the arm. This creates a state in which the first hook is pressed against the article, so that the article is unloaded onto the shelf with the first hook preferably abutting the article. When loading the article placed on the shelf onto the placement area, the conveyor is moved rearward at the speed lower than the retracting speed of the arm. This creates a state in which the second hook is pressed against the article, so that the article is loaded onto the placement area with the second hook preferably abutting the article. Accordingly, occurrence of breakage and positional deviation of the article is prevented in both cases when the load is unloaded onto the shelf and when the load is loaded onto the placement area. Thus, the article is stably transferred.

The arm preferably includes an article detection sensor configured to detect the rear end of the article placed on the shelf, in a position between the first hook and the second hook in the front-and-rear direction, the position being near the second hook. The controller preferably is configured or programmed to calculate a first position of the arm that allows the second hook to abut the front end of the article placed on the shelf, based on a position of the arm where the article detection sensor detects the front end of the article placed on the shelf when the arm stretches. When the article placed on the shelf is loaded onto the placement area, the controller preferably is configured or programmed to move the arm at a first retracting speed to a second position that is anterior to the first position, move the arm at a second retracting speed lower than the first retracting speed from the second position to the first position, and move the arm at a third retracting speed higher than the second retracting speed while moving the conveyor rearward at a fourth speed lower than the third retracting speed. In this case, when the arm stretches prior to loading the article placed on the shelf onto the placement area, the first position of the arm where the second hook abuts the front end of the article placed on the shelf is calculated, based on the position of the arm where the article detection sensor detects the front end of the article placed on the shelf. When loading the article placed on the shelf onto the placement area, the arm is moved at the second retracting speed from the second position to the first position where the second hook approaches and abuts the front end of the article, and the arm is moved at the first retracting speed and the third retracting speed that are higher than the second retracting speed in the other positions. Thus, time required for loading the article is shortened.

The conveyor preferably includes a first conveyor and a second conveyor provided on the front side of the first conveyor in the front-and-rear direction. The controller preferably is configured or programmed to adjust positions of two articles on the conveyor when the two articles are placed on the conveyor, by independently driving the first conveyor and the second conveyor. In this case, the positions of the two articles on the conveyor are preferably adjusted, such that transfer is efficiently performed without stopping operation of the transfer device.

Preferred embodiments of the present invention provide a transfer device that stably transfers articles.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a front view of a transfer device according to a preferred embodiment of the present invention.

FIG. 2 is a plan view of the transfer device of FIG. 1.

FIG. 3 is a plan view illustrating movement when the transfer device of FIG. 1 loads an article onto a placement area.

FIGS. 4A-4C are graphs illustrating input of an article detection sensor, retracting speed of an arm, and speed of a conveyor when the transfer device of FIG. 1 loads the article onto the placement area.

FIG. 5 is a plan view illustrating movement when the transfer device of FIG. 1 unloads the article onto a shelf.

FIGS. 6A-6C are graphs illustrating input of the article detection sensor, stretching speed of the arm, and speed of the conveyor when the transfer device of FIG. 1 unloads the article onto the shelf.

FIGS. 7A and 7B are plan views illustrating examples of movement when positions of two articles are adjusted in the transfer device of FIG. 1.

FIGS. 8A-8C are plan views illustrating examples of movement when positions of two articles are adjusted in the transfer device of FIG. 1.

FIGS. 9A-9C are plan views illustrating examples of movement when positions of two articles are adjusted in the transfer device of FIG. 1.

FIGS. 10A-10C are plan views illustrating examples of movement when positions of two articles are adjusted in the transfer device of FIG. 1.

FIGS. 11A-11C are plan views illustrating examples of movement when positions of two articles are adjusted in the transfer device of FIG. 1.

### DETAILED DESCRIPTION OF THE PREFERRED EMBODIMENTS

Preferred embodiments of a transfer device of the present invention will now be described in detail with reference to the drawings. Like reference signs indicate like or corresponding components, and duplicated description is omitted.

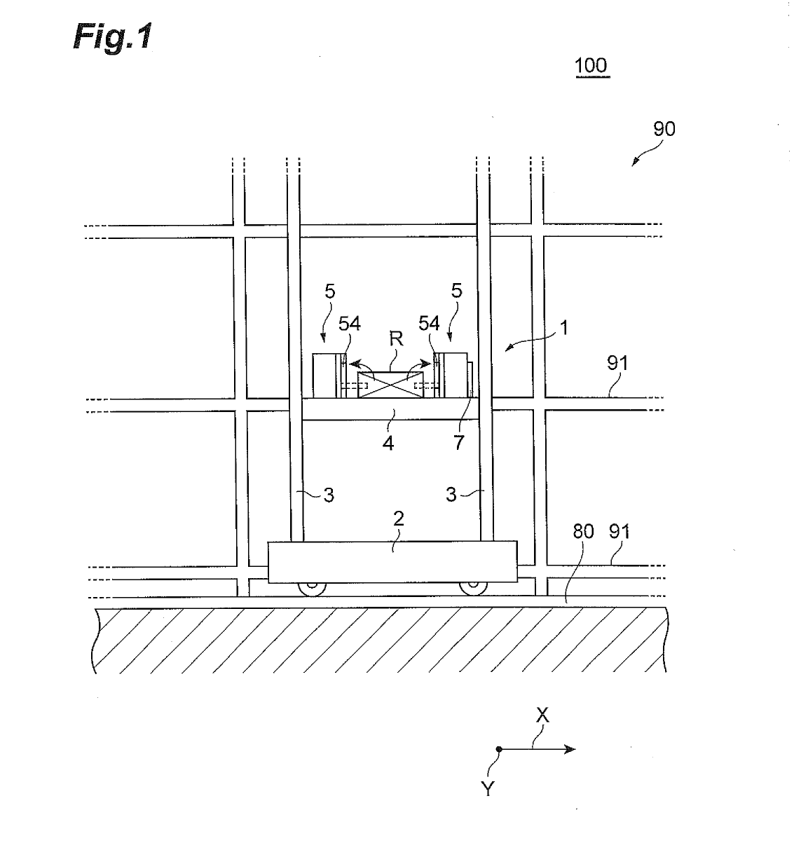

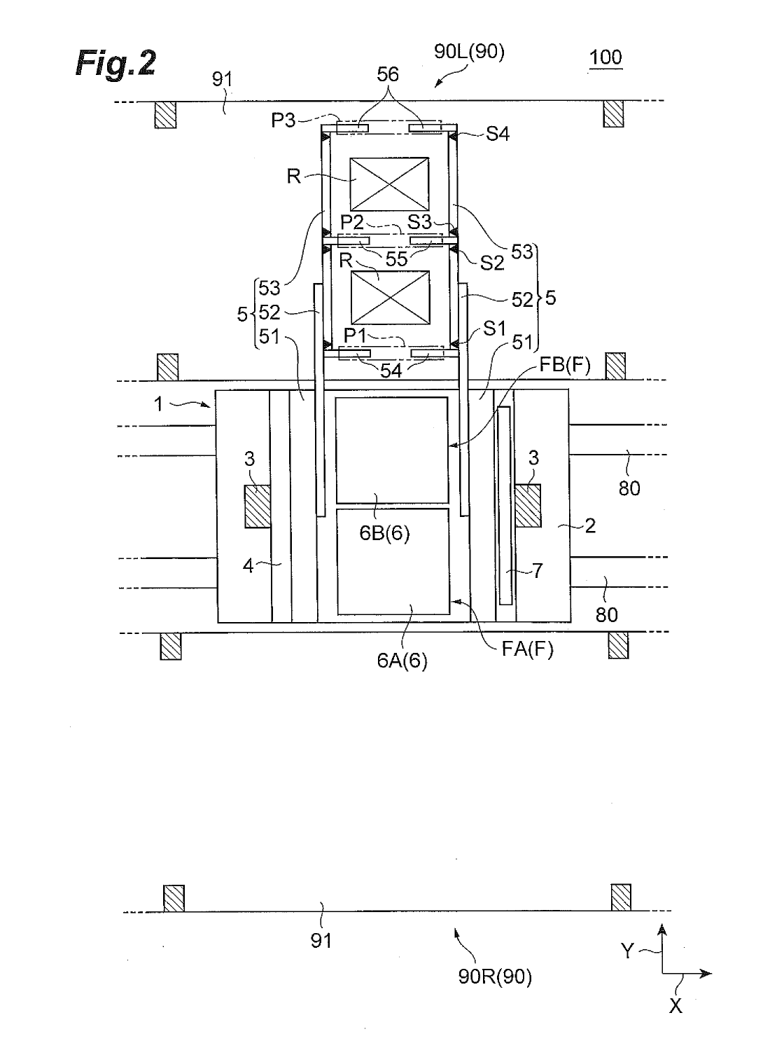

FIG. 1 is a front view of a transfer device according to a preferred embodiment of the present invention, and FIG. 2 is a plan view of the transfer device of FIG. 1. As depicted in FIGS. 1 and 2, a stacker crane (transfer device) 1 is, for example, arranged in a building 100 and transfers article R such as containers or cardboards to or from a rack 90.

The rack 90 stores the article R. A plurality of racks 90 is provided in the building 100. Each rack 90 extends in a predetermined X-direction (horizontal direction). Neighboring racks 90L and 90R are arranged in parallel or approximately parallel facing each other. In each rack 90, a plurality of shelves 91 storing article R extends along the X-direction and the vertical direction. In the racks 90, the article R is brought in and out from an area between the opposing racks 90L and 90R. On the area between the opposing racks 90L and 90R, rails 80 for the stacker crane 1 to travel thereon are provided.

The stacker crane 1 brings in and out the article R onto and from the shelves 91. The stacker crane 1 is arranged in the area between the opposing racks 90L and 90R. The stacker crane 1 includes a traveling truck 2 that travels along the rails 80, two supporting devices 3 and 3 that are erected on the traveling truck 2, and a lifting platform 4 that ascends and descends along the supporting devices 3 and 3. The stacker crane 1 moves in the X-direction along the racks 90 by traveling along the rails 80. This movement enables the stacker crane 1 to bring in and out the article R onto and from the shelves 91 that are provided along the X-direction. The stacker crane 1 raises and lowers the lifting platform 4, thus being capable of bringing in and out the article R onto and from the shelves 91 that are provided along the vertical direction.

Because transfer between the stacker crane 1 and the rack 90L and transfer between the stacker crane 1 and the rack 9 OR are performed in the same manner, the transfer between the stacker crane 1 and the rack 90L will be described hereinafter. The direction that is a horizontal direction and is perpendicular or substantially perpendicular to the X-direction is the Y-direction (front-and-rear direction). In the Y-direction, the side of the rack 90L is the front side, and the side of the stacker crane 1 is the rear side.

The stacker crane 1 includes a placement area F on the lifting platform 4 on which the article R is placed. The placement area F includes a placement area (first placement area) FA provided on the rear side and a placement area (second placement area) FB provided on the front side. The stacker crane 1 transfers the article R onto and from the shelf 91 positioned ahead of the placement area FB. On each of the placement area FA and the placement area FB, the article R is capable of being placed. The stacker crane 1 includes a pair of arms 5 and 5, a conveyor 6, and a controller 7 on the lifting platform 4.

The pair of the arms 5 and 5 are spaced apart from each other along the X-direction. The arm 5 extends along the Y-direction, and is configured to stretch and retract along the Y-direction. Specifically, the arm 5 has a telescopic structure including a base portion 51, a middle portion 52, and a top portion 53. The base portion 51, the middle portion 52, and the top portion 53 each are a member extending along the Y-direction.

When the middle portion 52 is advanced toward a shelf 91 side with respect to the base portion 51 by a drive source, in conjunction with this movement, the top portion 53 is advanced toward the shelf 91 side with respect to the middle portion 52. In other words, the arm 5 stretches forward along the Y-direction. When the middle portion 52 is retreated from the shelf 91 side with respect to the base portion 51 by the drive source, in conjunction with this movement, the top portion 53 is retreated from the shelf 91 side with respect to the middle portion 52. In other words, the arm 5 retracts rearward along the Y-direction.

The top portion 53 includes a hook 54, a hook 55, and a hook 56 that are used to move the article R. The hook 54 is provided to a rear end of the top portion 53 in the Y-direction. The hook 55 is provided to a middle of the top portion 53 in the Y-direction. The hook 56 is provided to a front end of the top portion 53 in the Y-direction.

The hook 54 is configured to be rotated about an axis line parallel or substantially parallel to the Y-direction by a drive source. This rotation enables the hook 54 to enter and exit an abutment position P1 where the hook 54 abuts the article R. When unloading the article R placed on the placement area FA onto the shelf 91, the hooks 54 and 54 enter the abutment position P1 and abut the rear end of the article R placed on the placement area FA. By stretching the arms 5 and 5 forward from this state, the article R placed on the placement area FA is unloaded onto the shelf 91.

The hook 55 is configured to be rotated about an axis line parallel or substantially parallel to the Y-direction by a drive source. This rotation enables the hook 55 to enter and exit an abutment position P2 where the hook 55 abuts the article R. When unloading the article R placed on the placement area FB onto the shelf 91, the hooks 55 and 55 enter the abutment position P2, and abut the rear end of the article R placed on the placement area FB. By stretching the arms 5 and 5 forward from this state, the article R placed on the placement area FB is unloaded onto the shelf 91.

When loading the article R placed on the shelf 91 onto the placement area FA, the hooks 55 and 55 enter the abutment position P2, and abut the front end of the article R placed on the shelf 91. By retracting the arms 5 and 5 rearward from this state, the article R placed on the shelf 91 is loaded onto the placement area FA.

The hook 56 is configured to be rotated about an axis line parallel or substantially parallel to the Y-direction by a drive source. This rotation enables the hook 55 to enter and exit an abutment position P3 where the hook 56 abuts the article R. When loading the article R placed on the shelf 91 onto the placement area FB, the hooks 56 and 56 enter the abutment position P3, and abut the front end of the article R placed on the shelf 91. By retracting the arms 5 and 5 rearward from this state, the article R placed on the shelf 91 is loaded onto the placement area FB.

The top portion 53 includes load detection sensors S1 to S4 to detect the article R. The article detection sensors S1 to S4 preferably include, for example, light sensors and each of which includes a light-emitting portion provided to one of the arms 5 and a light-receiving portion provided to the other of the arms 5. The article detection sensor S1 is arranged in a position between the hook 54 and the hook 55 in the Y-direction, the position being near the hook 54 (position slightly ahead of the hook 54). The article detection sensor S2 is arranged in a position between the hook 54 and the hook 55 in the Y-direction, the position being near the hook 55 (position slightly in the rear of the hook 55). The article detection sensor S3 is arranged in a position between the hook 55 and the hook 56 in the Y-direction, the position being near the hook 55 (position slightly ahead of the hook 55). The article detection sensor S4 is arranged in a position between the hook 55 and the hook 56 in the Y-direction, the position being near the hook 56 (position slightly in the rear of the hook 56).

The conveyor 6 is provided at the placement area F, and moves the articles R along the Y-direction. The conveyor 6 includes a conveyor (first conveyor) 6A provided in the placement area FA and a conveyor (second conveyor) 6B provided in the placement area FB. The conveyor 6A and the conveyor 6B each are provided below the arms 5.

The controller 7 is configured or programmed to control movement of each component of the stacker crane 1. The controller 7 preferably includes an electronic control unit including a CPU, a ROM, and a RAM, for example. To the controller 7, information required to perform control is input from each component of the stacker crane 1. The controller 7 loads a program stored in the ROM into the RAM for the CPU to execute the program, thus configuring each processor with software. Herein, each processor may be configured with hardware.

The following describes movement of the stacker crane 1. The case when the article R placed on the shelf 91 is loaded onto the placement area F will be described first.

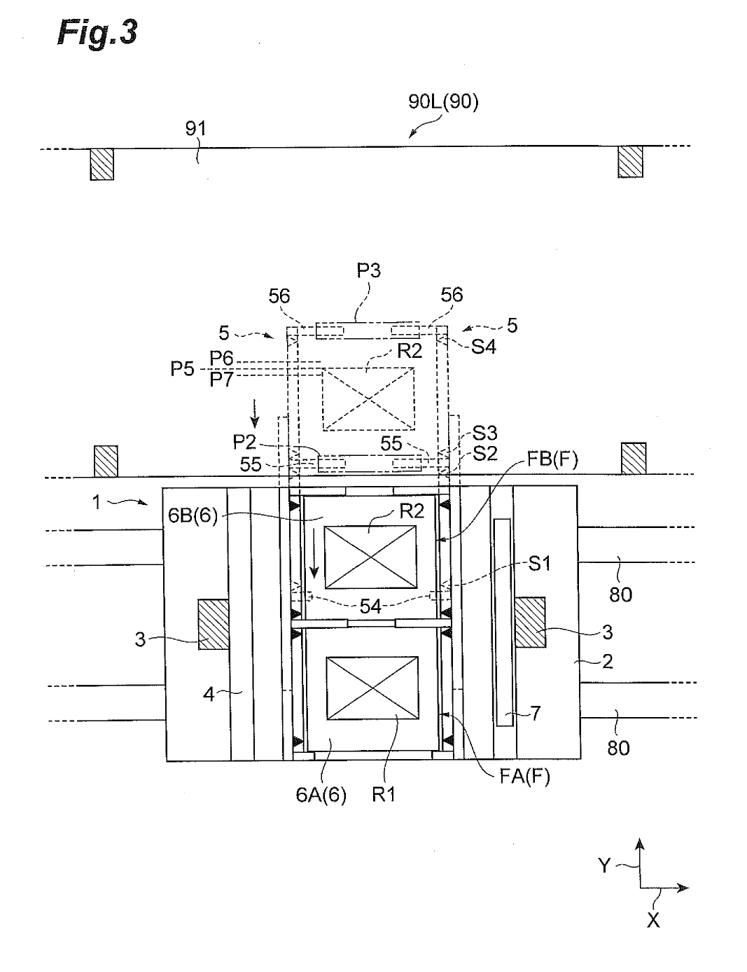

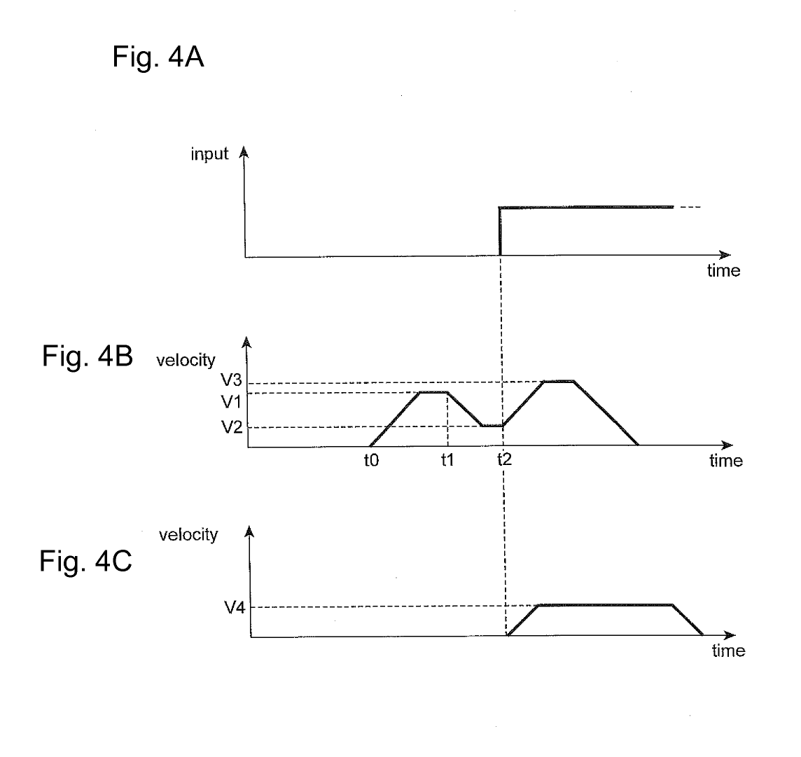

FIG. 3 is a plan view illustrating movement when the transfer device of FIG. 1 loads an article onto a placement area. FIGS. 4A-4C are graphs illustrating input of an article detection sensor, retracting speed of an arm, and speed of a conveyor when the transfer device of FIG. 1 loads the article onto the placement area. FIG. 4A illustrates input of the article detection sensor S4. FIG. 4B illustrates retracting speed of the arm 5. FIG. 4C illustrates speed of the conveyor 6B.

FIG. 3 illustrates a case when one article R2 placed on the shelf 91 is loaded onto the placement area FB. In this case, the hooks 56 and 56 define and function as the second hook that abuts the front end of the article R2. The abutment position P3 is the second abutment position that the hooks 56 enter.

As depicted in FIG. 3, in the stacker crane 1, when the arms 5 and 5 stretch prior to loading the article R2 onto the placement area FB, the article detection sensor S4 passes over the front end of the article R2. At this time, the article detection sensor S4 switches from a detection state to a non-detection state and detects the front end of the article R2. At this time, input of a signal from the article detection sensor S4 to the controller 7 stops. Based on the position of the arms 5 and 5 and the spacing between the hooks 56 and 56 and the article detection sensor S4, the controller 7 calculates and stores a position (first position) P5 of the arms 5 and 5 where the hooks 56 and 56 start to abut the front end of the article R2 when the arms 5 and 5 retract. The controller 7 moves the hooks 55 and 55 to the abutment position P2 and moves the hooks 56 and 56 to the abutment position P3, after the arms 5 and 5 stretch. Herein, the hooks 55 and 55 do not have to be moved to the abutment position P2.

As depicted in FIG. 4B, when the article R2 is loaded onto the placement area FB, to begin with, the controller 7 starts retracting the arm 5 at time t0. The controller 7 then accelerates the arm 5 up to a retracting speed (first retracting speed) V1.

Subsequently, when the article detection sensor S4 reaches a position (second position) P6 (see FIG. 3) that is anterior to the position P5 at time t1, the controller 7 decelerates the arm 5 down to a retracting speed (second retracting speed) V2 lower than the retracting speed V1. The position P6 herein is set so that the arm 5 is decelerated from the retracting speed V1 to the retracting speed V2 before the arm 5 reaches the position P5 and the hooks 56 abut the front end of the article R2.

Subsequently, when the arm 5 reaches the position P5 and the hooks 56 abut the front end of the article R2 at time t2, the controller 7 accelerates the arm 5 up to a retracting speed (third retracting speed) V3 higher than the retracting speed V2 as depicted in FIG. 4B. The retracting speed V3 herein preferably is set to be higher than the retracting speed V1.

In addition, when the arm 5 reaches the position P5 and the hooks 56 abut the front end of the article R2, the controller 7 moves the conveyor 6B rearward at a speed (fourth speed) V4 lower than the retracting speed V3 as depicted in FIG. 4C.

When the rear end of the article R2 rides onto the conveyor 6B, the hooks 56 will be pressed against the front end of the article R2 because the conveyor 6B moves at the speed V4 lower than the retracting speed V3 of the arms 5. Accordingly, the article R2 is transferred with the hooks 56 preferably abutting the article R2. After the whole of the article R2 rides on the conveyor 6B, the controller 7 stops retracting the arms 5. After the article R2 is moved to a desired position by the conveyor 6B, the controller 7 stops the conveyor 6B, and thus a series of operations ends.

The following describes a case when the article R placed on the placement area F is unloaded onto the shelf 91.

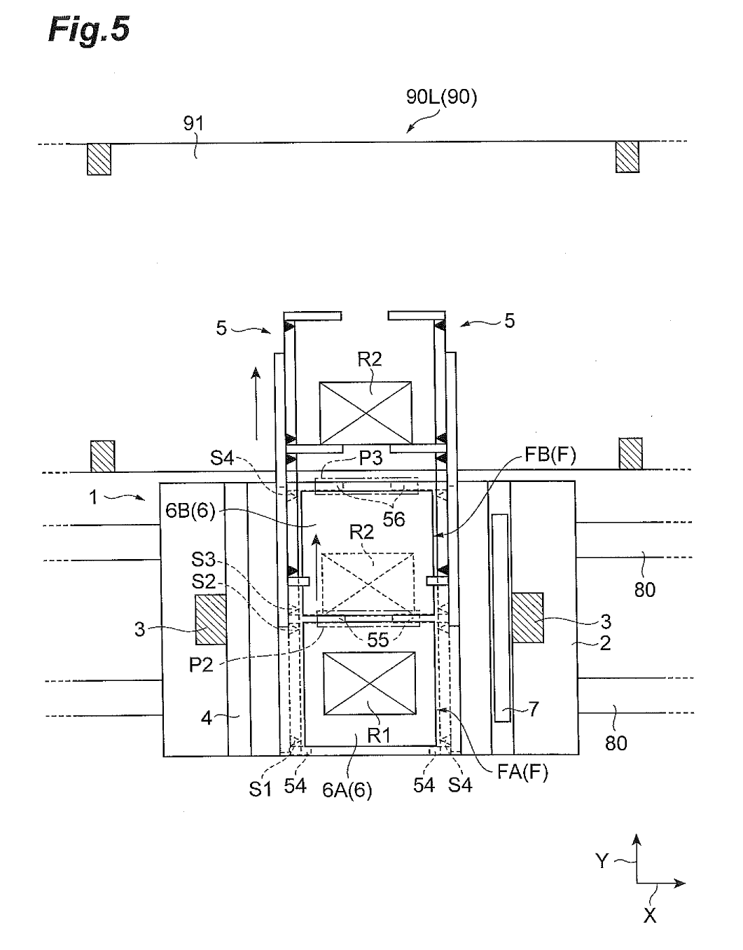

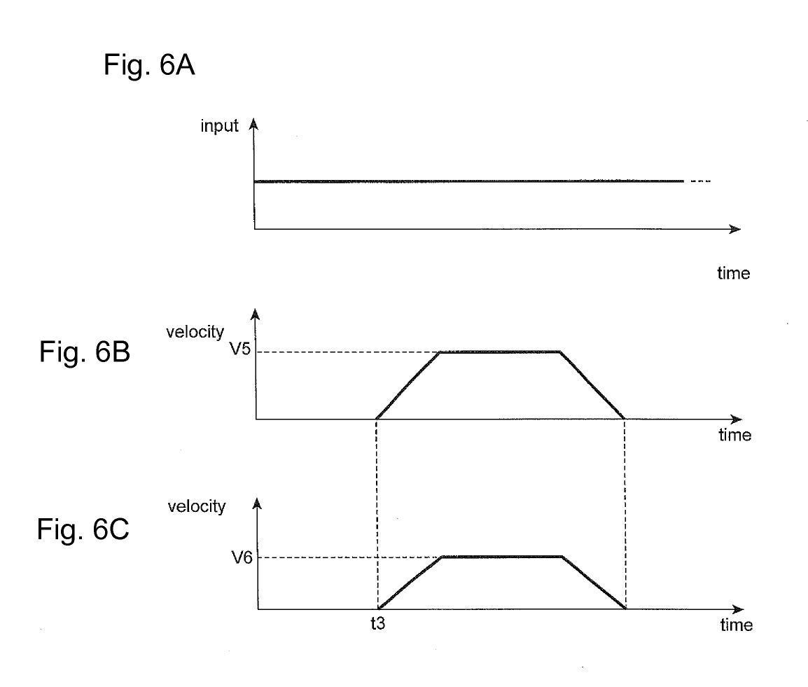

FIG. 5 is a plan view illustrating movement when the transfer device of FIG. 1 unloads the article onto a shelf. FIGS. 6A-6C are graphs illustrating input of an article detection sensor, stretching speed of an arm, and speed of a conveyor when the transfer device of FIG. 1 unloads the article onto the shelf. FIG. 6A illustrates input of the article detection sensor S3. FIG. 6B illustrates the stretching speed of the arm 5. FIG. 6C illustrates speed of the conveyor 6B.

FIG. 5 illustrates a case when only the article R2 placed on the placement area FB is unloaded onto the shelf 91. In this case, the hooks 55 define and function as the first hook that abuts the rear end of the article R2. The abutment position P2 is the second abutment position that the hooks 55 enter.

As depicted in FIG. 5, the controller 7 moves the hooks 55 and 55 to the abutment position P2, and moves the hooks 56 and 56 to enter the abutment position P3, before the article R2 is unloaded onto the shelf 91. Herein, the hooks 56 and 56 do not have to be moved to the abutment position P2. The controller 7 moves the conveyor 6B rearward, and thus the hooks 55 and 55 abut the rear end of the article R2. Accordingly, the article detection sensor S3 switches to the detection state, and thus a signal is input from the article detection sensor S3 to the controller 7.

As depicted in FIGS. 6B and 6C, when the article R2 is unloaded onto the shelf 91, the controller 7 starts stretching the arm 5 at time t3, and accelerates the arm 5 up to a stretching speed V5. The controller 7 also moves the conveyor 6B forward at a speed V6 lower than the stretching speed V5. Because the conveyor 6B moves at the speed V6 lower than the stretching speed V5 of the arms 5 and 5, the hooks 55 and 55 will be pressed against the rear end of the article R2. Accordingly, the article R2 is transferred with the hooks 55 preferably abutting the article R2. After the whole of the article R2 rides on the shelf 91 and the article R2 is moved to a desired position by the arms 5 and 5, the controller 7 stops the arms 5 and the conveyor 6B, and thus a series of operations ends.

As described above, in the stacker crane 1 of the present preferred embodiment, the article R2 is moved by the arms 5 and 5 and the conveyors 6A and 6B. When unloading the article R2 placed on the placement area FB onto the shelf 91, the conveyor 6B is moved forward at the speed V6 lower than the stretching speed V5 of the arms 5. This creates a state in which the hooks 55 are pressed against the article, so that the article R2 is unloaded onto the shelf 91 with the hooks 55 preferably abutting the article R2. When loading the article R2 placed on the shelf 91 onto the placement area FB, the conveyor 6B is moved rearward at the speed V4 lower than the retracting speed V3 of the arms 5. This creates a state in which the hooks 56 are pressed against the article R2, so that the article R2 is loaded onto the placement area FB with the hooks 56 preferably abutting the article R2. Accordingly, occurrence of breakage and positional deviation of the article R2 is prevented in both cases when the article R2 is unloaded onto the shelf 91 and when the article R2 is loaded onto the placement area FB. Thus, the article R2 is stably transferred. Furthermore, because the article R2 is moved by the arms 5 and 5 and also by the conveyor 6B, loads on the arms 5 are reduced.

In the stacker crane 1, the arms 5 and 5 include the article detection sensor S4 configured to detect the front end of the article R2 placed on the shelf 91, in a position between the hook 55 and the hook 56 in the Y-direction, the position being near the hook 56. The controller 7 preferably is configured or programmed to calculate the position P5 of the arm 5 where the hooks 56 can abut the front end of the article R2 placed on the shelf 91, based on the position of the arm 5 where the article detection sensor S4 detects the front end of the article R2 when the arms 5 and 5 stretch. When the article R2 placed on the shelf 91 is loaded onto the placement area FB, the controller 7 moves the arms 5 and 5 at the retracting speed V1 to the position P6 anterior to the position P5, moves the arms 5 and 5 at the retracting speed V2 lower than the retracting speed V1 from the position P6 to the position P5, and moves the arms 5 and 5 at the retracting speed V3 higher than the retracting speed V2 while moving the conveyor 6B rearward at the speed V4 lower than the retracting speed V3. Accordingly, when the arms 5 and 5 stretch prior to loading the article R2 placed on the shelf 91 onto the placement area FB, the position P5 of the arm where the hooks 56 abut the front end of the article R2 is stored, based on the position of the arm 5 where the article detection sensor S4 detects the front end of the article R2. When loading the article R2 onto the placement area FB, the arms 5 and 5 move at the retracting speed V2 from the position P6 to the position P5 where the hooks 56 and 56 approach and abut the front end of the article R2, and the arms 5 and 5 move at the retracting speed V1 and the retracting speed V3 that are higher than the retracting speed V2 in the other positions. Thus, time required for loading the article R2 is shortened.

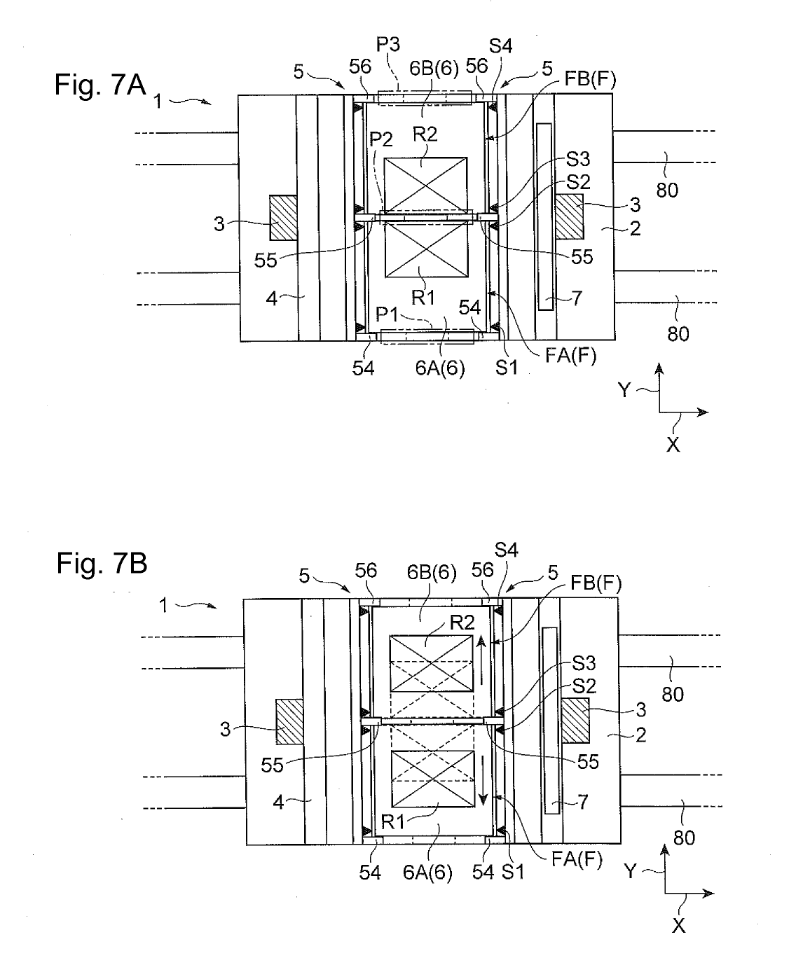

The following describes a case of adjusting positions of two articles R1 and R2 when the articles R1 and R2 are placed on the placement area F. FIGS. 7A to 11C are plan views illustrating examples of movement when the positions of the two articles are adjusted in the transfer device of FIG. 1.

As the case of adjusting the positions of the articles R1 and R2 in the stacker crane 1, a case can be considered, for example, in which the articles R1 and R2 are transferred between the stacker crane 1 and a transfer station for shipping and receiving in the building 100. There are occasions in which the transfer station includes a conveyor, and when transfer is performed between the stacker crane 1 and the transfer station, the conveyor 6 of the stacker crane 1 and the conveyor of the transfer station may be used to perform the transfer without using the arms 5. In this case, for example, if the articles R1 and R2 abut each other when the articles R1 and R2 are loaded from the transfer station onto the stacker crane 1, the hooks 54 to 56 cannot enter the abutment positions P1 to P3. Furthermore, for example, if the articles R1 and R2 abut each other when the articles R1 and R2 are unloaded from the stacker crane 1 onto the transfer station, the transfer station may mistakenly recognize that the number of the articles is one. In such cases, because the necessity of stopping operation of the stacker crane 1 may arise, it is preferable to adjust spacing between the two articles in the stacker crane 1.

In one example, as depicted in FIG. 7A, the article R1 is placed on the placement area FA along the front end of the placement area FA. Accordingly, the article detection sensor S2 is in the detection state. The article R2 is placed on the placement area FB along the rear end of the placement area FB. Accordingly, the article detection sensor S3 is in the detection state. In this case, if the hooks 55 and 55 rotate to the abutment position P2, the hooks 55 and 55 may hit the upper surfaces of the articles R1 and R2 because spacing between the articles R1 and R2 is small. Thus, there is a possibility that the hooks 55 and 55 cannot enter the abutment position P2.

In view of this, as depicted in FIG. 7B, the conveyor 6A is moved rearward until the article detection sensor S2 switches from the detection state to the non-detection state, and the conveyor 6B is moved forward until the article detection sensor S3 switches from the detection state to the non-detection state. By these movements, the article R1 is placed in a central portion of the placement area FA, and the article R2 is placed in a central portion of the placement area FB. This enables the hooks 55 and 55 to enter the abutment position P2.

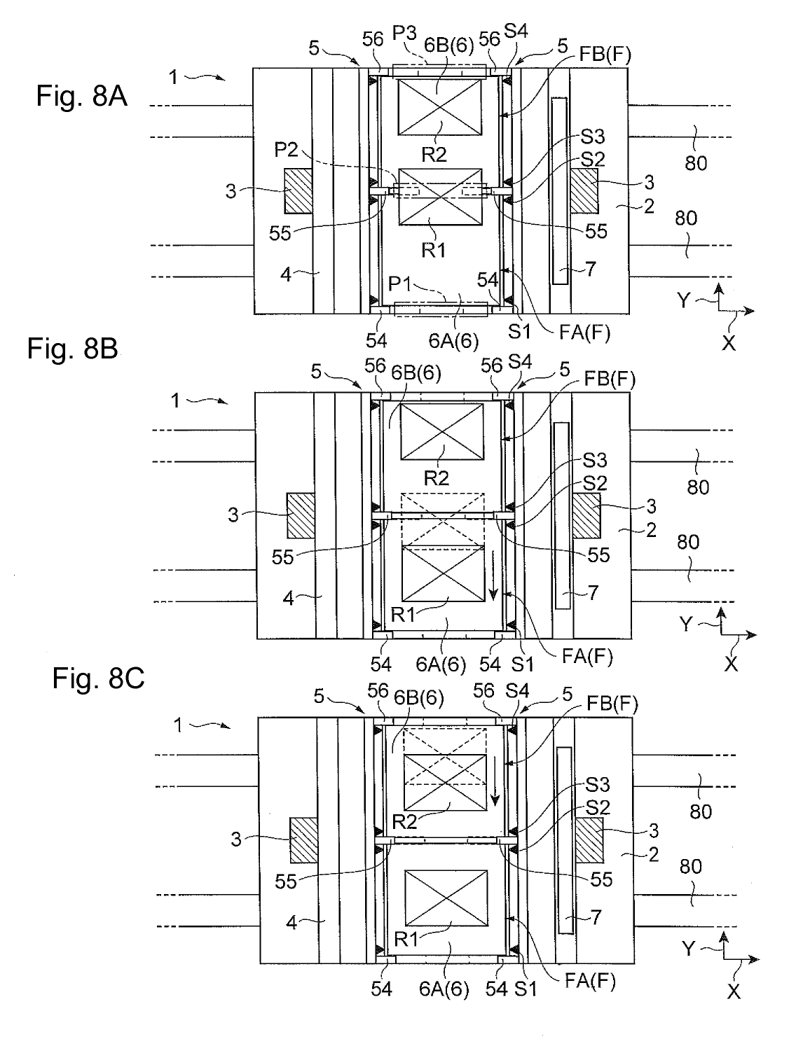

In another example, as depicted in FIG. 8A, the article R1 is placed astride the placement areas FA and FB. Accordingly, the article detection sensors S2 and S3 are in the detection state. The article R2 is placed on the placement area FB along the front end of the placement area FB. Accordingly, the article detection sensor S4 is in the detection state. In this case, if the hooks 55 and 55 rotate to the abutment position P2, the hooks 55 and 55 may hit the upper surface of the article R1. Furthermore, if the hooks 56 and 56 rotate to the abutment position P3, the hooks 56 and 56 may hit the upper surface of the article R2. Thus, there are possibilities that the hooks 55 and 55 cannot enter the abutment position P2 and that the hooks 56 and 56 cannot enter the abutment position P3.

In view of this, to begin with, the conveyor 6A is moved rearward until the article detection sensors S2 and S3 switch from the detection state to the non-detection state as depicted in FIG. 8B.

Subsequently, the conveyor 6B is moved rearward until the article detection sensor S4 switches from the detection state to the non-detection state as depicted in FIG. 8C. By these movements, the article R1 is placed in a central portion of the placement area FA, and the article R2 is placed in a central portion of the placement area FB. This enables the hooks 55 to enter the abutment position P2, and enables the hooks 56 to enter the abutment position P3.

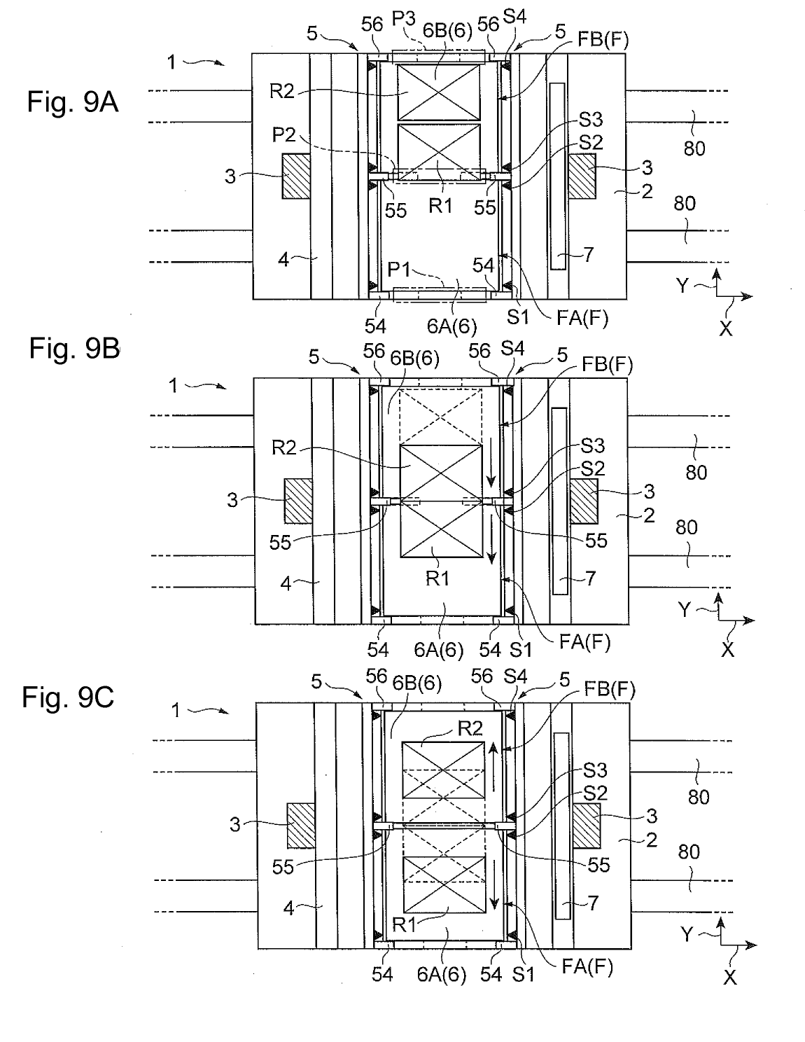

In still another example, as depicted in FIG. 9A, the article R1 is placed on the placement area FB, and is slightly protruding from the placement area FB with lying along the front end of the placement area FA. Accordingly, the article detection sensor S3 is in the detection state. The article R2 is placed along the front end of the placement area FB, and the article detection sensor S4 is in the detection state. In this case, if the hooks 55 and 55 rotate to the abutment position P2, the hooks 55 and 55 may hit the upper surface of the article R1. Furthermore, if the hooks 56 and 56 rotate to the abutment position P3, the hooks 56 and 56 may hit the upper surface of the article R2. Thus, there are possibilities that the hooks 55 cannot enter the abutment position P2 and that the hooks 56 cannot enter the abutment position P3. In this case, because the two articles R1 and R2 are placed on the same conveyor 6B, the articles R1 and R2 cannot be transferred independently of each other.

In view of this, to begin with, both of the conveyors 6A and 6B are moved rearward until the article detection sensor S4 switches from the detection state to the non-detection state and until the article detection sensor S2 switches from the non-detection state to the detection state as depicted in FIG. 9B.

Subsequently, the conveyor 6A is moved rearward until the article detection sensor S2 switches from the detection state to the non-detection state, and the conveyor 6B is moved forward until the article detection sensor S3 switches from the detection state to the non-detection state as depicted in FIG. 9C. By these movements, the article R1 is placed in a central portion of the placement area FA, and the article R2 is placed in a central portion of the placement area FB. This enables the hooks 55 to enter the abutment position P2 and the hooks 56 to enter the abutment position P3. Furthermore, the articles R1 and R2 can be transferred independently of each other.

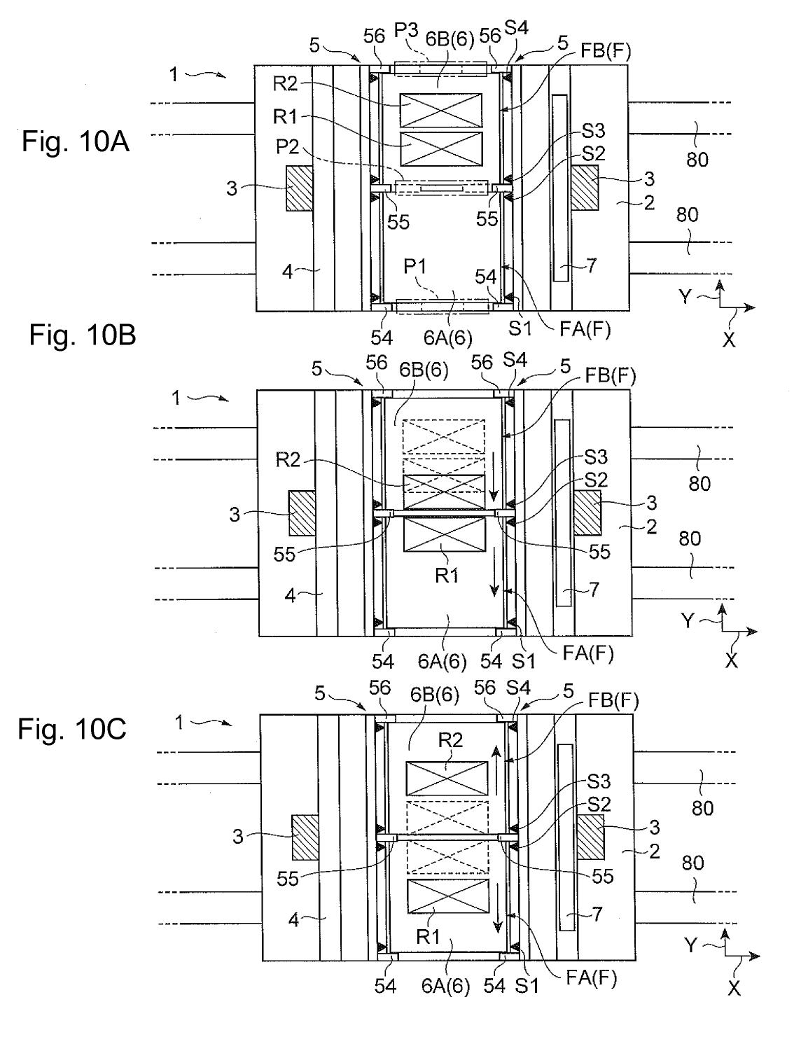

In still another example, as depicted in FIG. 10A, articles R1 and R2 the widths of which are relatively small in the Y-direction each are placed on a central portion of the placement area FB. In this case, because the two articles R1 and R2 are placed on the same conveyor 6B, the articles R1 and R2 cannot be transferred independently of each other.

In view of this, to begin with, both of the conveyors 6A and 6B are moved rearward until the article detection sensors S2 and S3 switch from the non-detection state to the detection state as depicted in FIG. 10B.

Subsequently, the conveyor 6A is moved rearward until the article detection sensor S2 switches from the detection state to the non-detection state, and the conveyor 6B is moved forward until the article detection sensor S3 switches from the detection state to the non-detection state as depicted in FIG. 10C. By these movements, the article R1 is placed in a central portion of the placement area FA, and the article R2 is placed in a central portion of the placement area FB. This enables the articles R1 and R2 to be transferred independently of each other.

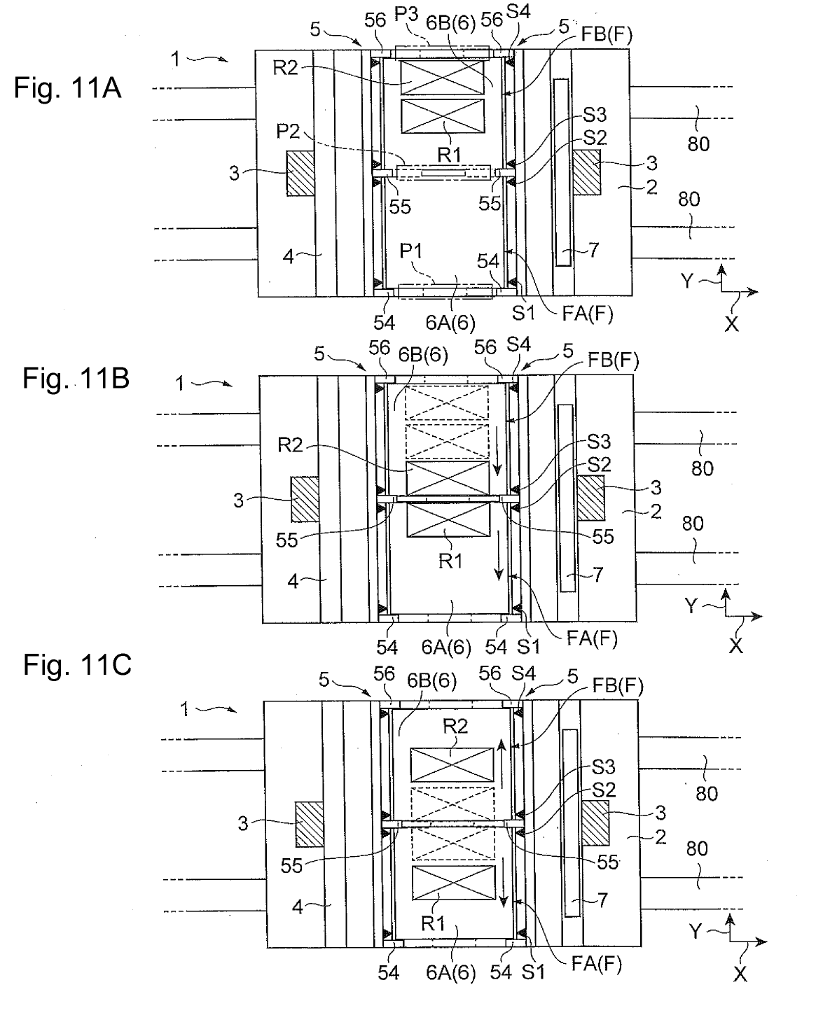

In still another example, as depicted in FIG. 11A, an article R1, the width of which is relatively small in the Y-direction, is placed in a central portion of the placement area FB, and an article R2, which is relatively small in the same manner, is placed on the placement area FB along the front end of the placement area FB. In this case, if the hooks 56 and 56 rotate to the abutment position P3, the hooks 56 and 56 may hit the upper surface of the article R2. Thus, there is a possibility that the hooks 56 and 56 cannot enter the abutment position P3. In this case, because the two articles R1 and R2 are placed on the same conveyor 6B, the articles R1 and R2 cannot be transferred independently of each other.

In view of this, to begin with, both of the conveyors 6A and 6B are moved rearward until the article detection sensors S2 and S3 switch from the non-detection state to the detection state as depicted in FIG. 11B.

Subsequently, the conveyor 6A is moved rearward until the article detection sensor S2 switches from the detection state to the non-detection state, and the conveyor 6B is moved forward until the article detection sensor S3 switches from the detection state to the non-detection state as depicted in FIG. 11C. By these movements, the article R1 is placed in a central portion of the placement area FA, and the article R2 is placed in a central portion of the placement area FB. This enables the hooks 56 and 56 to enter the abutment position P3. Furthermore, the articles R1 and R2 are capable of being transferred independently of each other.

As described above, in the stacker crane 1 of the present preferred embodiment, the conveyor 6 includes the conveyor 6A that defines and functions as the first conveyor and the conveyor 6B that defines and functions as the second conveyor provided on the front side of the conveyor 6A in the front-and-rear direction. When two articles R1 and R2 are placed on the conveyor 6, the controller 7 is configured or programmed to adjust the positions of the two articles R1 and R2 by independently driving the conveyor 6A and the conveyor 6B. This enables the positions of the two articles R1 and R2 on the conveyor 6 to be preferably adjusted, and thus transfer is efficiently performed without stopping operation of the stacker crane 1. Furthermore, for example, by performing this position adjustment of the two articles R1 and R2 during the transfer to the shelf 91 as a transfer destination, cycle time is reduced.

Preferred embodiments of the transfer device of the present invention have been described in the foregoing, but the present invention is not limited to the above-described preferred embodiments. For example, in the above-described preferred embodiments, a case has been described in which the article R2 placed on the shelf 91 is loaded onto the placement area FB by using the hook 56 in transfer between the stacker crane 1 and the rack 90L (see FIG. 3). However, the article R1 placed on the shelf 91 may be loaded onto the placement area FA by using the hook 55. In this case, it is assumed that the hooks 55 define and function as the second hook. It is also assumed in this case that the abutment position P2 is the second abutment position.

In the above-described preferred embodiments, a case has been described in which the article R2 placed on the placement area FB preferably is unloaded onto the shelf 91 by using the hook 55 in the transfer between the stacker crane 1 and the rack 90L (see FIG. 5), for example. However, the article R1 placed on the placement area FA may be loaded onto the shelf 91 by using the hook 54. In this case, it is assumed that the hooks 54 define and function as the first hook. It is also assumed in this case that the abutment position P1 is the first abutment position.

In the above-described preferred embodiments, transfer between the stacker crane 1 and the rack 90L has been described. However, transfer may be performed between the stacker crane 1 and the rack 90R. In this case, it is assumed that the side of the rack 90R is the front side and the side of the stacker crane 1 is the rear side, in the Y-direction. It is also assumed that the placement area FB is the first placement area and the placement area FA is the second placement area. In addition, the conveyor 6B defines and functions as the first conveyor, and the conveyor 6A defines and functions as the second conveyor.

When transfer is performed between the stacker crane 1 and the rack 90R, the article R2 placed on the shelf 91 may be loaded onto the placement area FB by using the hook 55. In this case, it is assumed that the hooks 55 and 55 define and function as the second hook. It is also assumed in this case that the abutment position P2 is the second abutment position.

When transfer is performed between the stacker crane 1 and the rack 90R, the article R1 placed on the shelf 91 may be loaded onto the placement area FA by using the hook 54. In this case, it is assumed that the hooks 54 and 54 define and function as the second hook. It is also assumed in this case that the abutment position P1 is the second abutment position.

When transfer is performed between the stacker crane 1 and the rack 90R, the article R1 placed on the placement area FA may be unloaded onto the shelf 91 by using the hook 55. In this case, it is assumed that the hooks 55 and 55 function as the first hook. It is also assumed in this case that the abutment position P2 is the first abutment position.

When transfer is performed between the stacker crane 1 and the rack 90R, the article R2 placed on the placement area FB is unloaded onto the shelf 91 by using the hook 56. In this case, it is assumed that the hooks 56 and 56 define and function as the first hook. It is also assumed in this case that the abutment position P3 is the first abutment position.

In the above-described preferred embodiments, as depicted in FIG. 3, the controller 7 preferably calculates the position P5 where the hooks 56 and 56 start to abut the front end of the article R2 when retracting the arms 5 and 5 as the first position of the arms 5 and 5 where the hooks 56 and 56 abut the front end of the article R2. However, as the first position of the arms 5 and 5 where the hooks 56 and 56 surely abut the front end of the article R2, a position (first position) P7 that is slightly posterior to the position P5 may be calculated.

Preferred embodiments of the present invention provide a transfer device that can stably transfer articles.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1.-3. (canceled)

4. A transfer device comprising:
an arm configured to stretch forward along a front-and-rear direction to unload an article placed on a placement area onto a shelf, and retract rearward along the front-and-rear direction to load the article placed on the shelf onto the placement area;
a conveyor provided at the placement area and configured to move the article along the front-and-rear direction; and
a controller configured or programmed to control movement of the arm and the conveyor; wherein
the arm includes:
a first hook configured to enter and exit a first abutment position that allows the first hook to abut the article, the first hook being configured to enter the first abutment position to abut a rear end of the article placed on the placement area when unloading the article placed on the placement area onto the shelf; and
a second hook configured to enter and exit a second abutment position that allows the second hook to abut the article, the second hook being configured to enter the second abutment position to abut a front end of the article placed on the shelf when loading the article placed on the shelf onto the placement area; wherein
the controller is configured or programmed to move the conveyor forward at a speed lower than a stretching speed of the arm when the article placed on the placement area is unloaded onto the shelf, and move the conveyor rearward at a speed lower than a retracting speed of the arm when the article placed on the shelf is loaded onto the placement area.

5. The transfer device according to claim 4, wherein
the arm includes an article detection sensor configured to detect the rear end of the article placed on the shelf, in a position between the first hook and the second hook in the front-and-rear direction;
the controller is configured or programmed to calculate a first position of the arm that allows the second hook to abut the front end of the article placed on the shelf, based on a position of the arm where the article detection sensor detects the front end of the article placed on the shelf when the arm stretches; and
when the article placed on the shelf is loaded onto the placement area, the controller is configured or programmed to move the arm at a first retracting speed to a second position that is anterior to the first position, move the arm at a second retracting speed lower than the first retracting speed from the second position to the first position, and move the arm at a third retracting speed higher than the second retracting speed while moving the conveyor rearward at a fourth speed lower than the third retracting speed.

6. The transfer device according to claim 4, wherein
the conveyor includes a first conveyor and a second conveyor provided on the front side of the first conveyor in the front-and-rear direction; and
the controller is configured or programmed to adjust positions of two articles on the conveyor when the two articles are placed on the conveyor, by independently driving the first conveyor and the second conveyor.

7. The transfer device according to claim 5, wherein
the conveyor includes a first conveyor and a second conveyor provided on the front side of the first conveyor in the front-and-rear-direction; and
the controller is configured or programmed to adjust positions of two articles on the conveyor when the two articles are placed on the conveyor, by independently driving the first conveyor and the second conveyor.
